(19) United States
(12) Patent Application Publication
(10) Pub. No.: US 2021/0390519 A1
(43) Pub. Date: Dec. 16, 2021

(54) STORAGE MEDIUM, DETECTION METHOD, AND DETECTION DEVICE

(71) Applicant: FUJITSU LIMITED, Kawasaki-shi (JP)

(72) Inventor: Tsuyoshi TANIGUCHI, Katsushika (JP)

(73) Assignee: FUJITSU LIMITED, Kawasaki-shi (JP)

(21) Appl. No.: 17/211,351

(22) Filed: Mar. 24, 2021

(30) Foreign Application Priority Data
Jun. 12, 2020 (JP) 2020-102104

(51) Int. Cl. G06Q 20/06; G06Q 20/38; G06Q 20/40

(52) U.S. Cl. CPC G06Q 20/065; G06Q 2220/00; G06Q 20/401; G06Q 20/3821

(57) ABSTRACT

A method executed by a computer, includes identifying, by using a blockchain indicating a cryptocurrency transaction, first addresses of a transaction source and a transaction partner in which the cryptocurrency transaction satisfying a condition has been performed in a first period;

generating, by using the first addresses, a first graph having the respective cryptocurrency addresses of the transaction source and the transaction partner; identifying, by using the blockchain, second addresses of a transaction source and a transaction partner in which the cryptocurrency transaction satisfying the condition has been performed in a second period; generating, by using the second addresses, a second graph having the respective cryptocurrency addresses of the transaction source and the transaction partner; and detecting, by using the first graph and the second graph, a new cryptocurrency address in which the cryptocurrency transaction has been performed under the condition.

### CROSS-REFERENCE TO RELATED APPLICATION

This application is based upon and claims the benefit of priority of the prior Japanese Patent Application No. 2020-102104, filed on Jun. 12, 2020, the entire contents of which are incorporated herein by reference.

### FIELD

The embodiments discussed herein are related to a storage medium, a detection method, and a detection device.

### BACKGROUND

In recent years, cryptocurrencies (also called crypto assets) such as bitcoin, using a public distributed ledger called blockchain, have been attracting attention from many people and media due to their convenience in transactions and the like. For the cryptocurrencies, transaction information (transactions) in the public distributed ledger can be viewed and traced by anyone on the Internet. Therefore, it is relatively easy to detect, trace, and verify abuses such as hacking and money laundering by attackers who carry out cyber attacks.

As one of countermeasures against malicious activities by such attackers, there is a known technique that provides a method of ensuring coherency and consistency of transaction data in a system that processes transaction information to specify behavior of one or more transactions and uses cryptocurrencies, thereby managing cryptocurrencies with more reliability. Japanese Laid-open Patent Publication No. 2016-151802 and the like are disclosed as related art.

### SUMMARY

According to an aspect of the embodiments, a method executed by a computer, includes identifying, by using a blockchain indicating a cryptocurrency transaction, first addresses of a transaction source and a transaction partner in which the cryptocurrency transaction satisfying a condition has been performed in a first period; generating, by using the first addresses, a first graph having the respective cryptocurrency addresses of the transaction source and the transaction partner; identifying, by using the blockchain, second addresses of a transaction source and a transaction partner in which the cryptocurrency transaction satisfying the condition has been performed in a second period; generating, by using the second addresses, a second graph having the respective cryptocurrency addresses of the transaction source and the transaction partner; and detecting, by using the first graph and the second graph, a new cryptocurrency address in which the cryptocurrency transaction has been performed under the condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration example of a detection device according to an embodiment;

FIG. 2 is an explanatory diagram for describing an example of a bitcoin transaction;

FIG. 3 is an explanatory diagram for describing an example of a bitcoin transaction;

FIG. 4 is an explanatory diagram for describing an example of transaction data;

FIG. 5 is a flowchart illustrating an example of transaction data collection processing;

FIG. 6 is an explanatory diagram illustrating an example of bitcoin address data;

FIG. 7 is a flowchart illustrating an example of graph creation processing;

FIG. 8 is an explanatory diagram for describing an example of edge data;

FIG. 9 is an explanatory diagram for describing an example of node data;

FIG. 10 is a flowchart illustrating an example of node selection processing;

FIG. 11 is an explanatory diagram for describing an example of selection node data;

FIG. 12 is a flowchart illustrating an example of graph comparison processing;

FIG. 13 is an explanatory diagram for describing an example of a detected malicious bitcoin address list;

FIG. 14 is an explanatory diagram for describing an example of a preliminary graph and a verification target graph;

FIG. 15 is a flowchart illustrating an example of threat information verification processing;

FIG. 16 is an explanatory diagram for describing an example of a verification result; and

FIG. 17 is a block diagram illustrating an example of a computer configuration.

### DESCRIPTION OF EMBODIMENTS

However, the above-described known technique has a problem of having a difficulty in verifying the malicious activities of indirectly abusing the cryptocurrency such as concealing information for abuse such as attack infrastructure information (for example, a C&C address) in transaction content and sending the information by a public distributed ledger.

For example, in the indirect abuse of the cryptocurrency, an attacker only moves (trades) a small amount of bitcoins between anonymously created bitcoin addresses, and this transaction itself is not an attack such as hacking. Therefore, it is difficult to detect and trace the abuse as compared with a case of directly abusing the cryptocurrency by hacking, money laundering, or the like.

In view of the foregoing, it is desirable to support verification of abuse of cryptocurrencies.

Hereinafter, a detection program, a detection method, and a detection device according to an embodiment will be described with reference to the drawings. Configurations with the same functions in the embodiments are denoted by the same reference signs, and redundant description will be omitted. Note that the detection program, the detection method, and the detection device described in the embodiment below are merely examples and do not limit the embodiment. Additionally, each of the embodiments below may be appropriately combined unless otherwise contradicted.

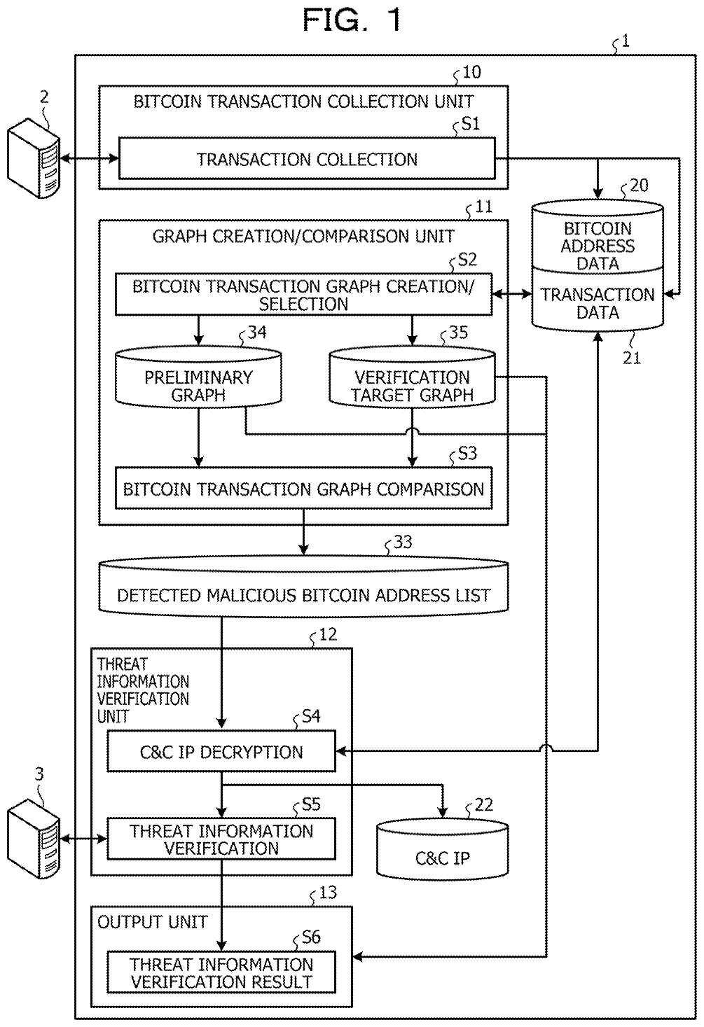

FIG. 1 is a block diagram illustrating a functional configuration example of a detection device according to an embodiment. As illustrated in FIG. 1, a detection device 1 is a device that detects an abuse of a cryptocurrency (Bitcoin in the present embodiment) by an attacker on the basis of a transaction illustrated in a blockchain 2 of the cryptocurrency. As the detection device 1, a computer such as a personal computer (PC) can be applied, for example. Note that the cryptocurrency (crypto asset) is not limited to the bitcoin and may be another cryptocurrency such as Litecoin as long as the cryptocurrency uses the blockchain 2.

The detection device 1 includes a bitcoin transaction collection unit 10, a graph creation/comparison unit 11, a threat information verification unit 12, and an output unit 13.

The bitcoin transaction collection unit 10 is a processing unit that performs transaction collection (S1) for collecting transaction data 21 indicating a cryptocurrency transaction from the blockchain 2. For example, the bitcoin transaction collection unit 10 performs the transaction collection (S1) regarding a transaction using a cryptocurrency address (malicious bitcoin address) related to the cryptocurrency for which maliciousness is reported in threat information such as Cyber Threat Intelligence (CTI) as an input, and the malicious bitcoin address as a starting point.

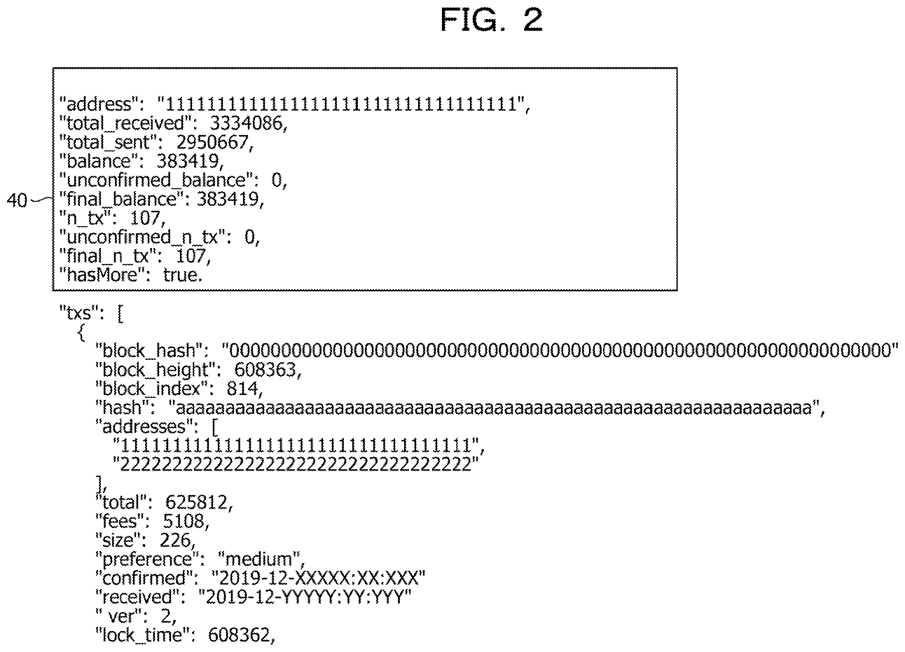

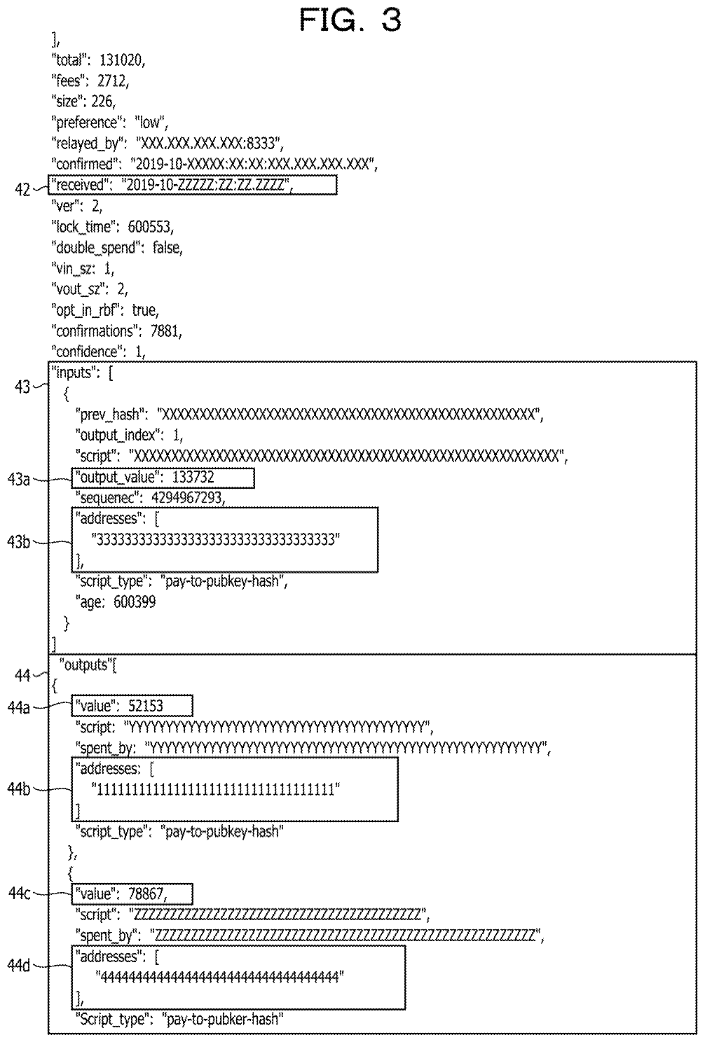

FIGS. 2 and 3 are explanatory diagrams for describing examples of bitcoin transactions. Specifically, FIGS. 2 and 3 are examples of bitcoin transactions collected from blockcypher.com. Furthermore, the file format in the bitcoin transactions is json format:

As illustrated in FIG. 2, a header section 40 of the collected bitcoin transaction illustrates data such as a bitcoin address (“address”), a total received (“total_received”), and a total sent (“total_sent”). Furthermore, in “txs” and the subsequent rows, a list of transactions continues in order from a transaction most recently added to the blockchain 2. For example, blockcyper.com can collect up to fifty transactions.

For each transaction, as illustrated in FIG. 3, a “received” area 42 illustrates date and time when the bitcoin system received this transaction. Furthermore, an “inputs” area 43 illustrates data on a transmission side, and an “outputs” area 44 illustrates data on a reception side.

For example, an “output_value” area 43a illustrates an amount of transmitted bitcoins in the smallest unit (satoshi). Furthermore, an “addresses” area 43b illustrates a transmission-side bitcoin address (transmission bitcoin address). Furthermore, “value” areas 44a and 44c illustrate an amount of received bitcoins in the minimum unit (satoshi). Furthermore, “addresses” areas 44b and 44d illustrate a reception-side bitcoin address (reception bitcoin address).

The bitcoin transaction collection unit 10 mainly acquires the transmission bitcoin address, the reception bitcoin address, the date and time when the transaction has been received by the bitcoin system, and the amount of sent(received) bitcoins as the transaction data 21 from the blockchain 2.

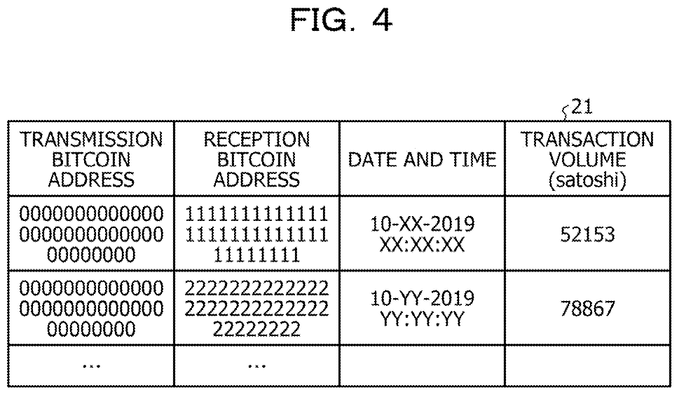

FIG. 4 is an explanatory diagram for describing an example of the transaction data 21. As illustrated in FIG. 4, the transaction data 21 stores the transmission-side bitcoin address in the “transmission bitcoin address”. Furthermore, the transaction data 21 stores the reception-side bitcoin address in the “reception bitcoin address”. Furthermore, the transaction data 21 stores the date and time when the transaction has been received by the bitcoin system in the “date and time”. Furthermore, the transaction data 21 stores the amount of bitcoins traded in the “transaction volume” in satoshi units.

Note that, due to the mechanism of bitcoin, a plurality of transmission/reception addresses can be set in one transaction. For example, in the example of FIG. 3, bitcoins are sent to a plurality of bitcoin addresses. In this case, each transaction is stored as data in the transaction data 21.

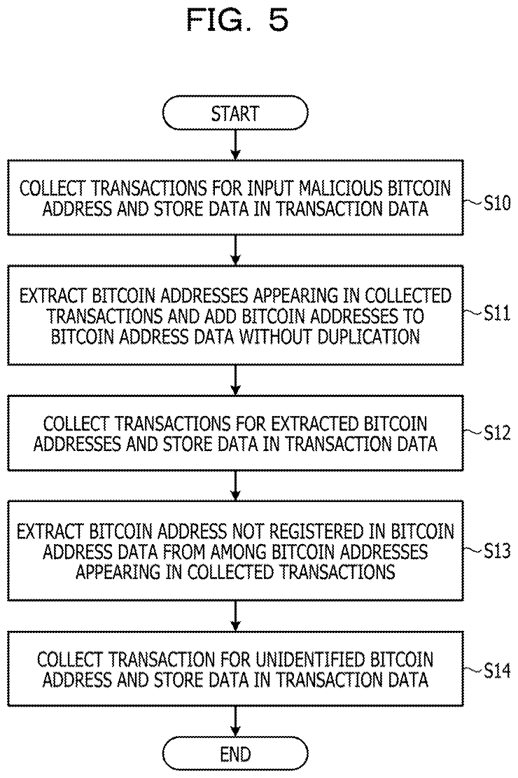

FIG. 5 is a flowchart illustrating an example of transaction data collection processing. Note that, in transaction data collection, a specific day, or in short, all the transactions from the start of the bitcoin system to the present can be collected and analyzed. However, one of main points in the present embodiment is to capture a behavior associated with a specific attack. Therefore, in the transaction data collection processing, a transaction is collected starting from the malicious bitcoin address obtained (input) on the basis of the threat information such as CTI.

As illustrated in FIG. 5, when the processing is started, the bitcoin transaction collection unit 10 collects the transactions for the input malicious bitcoin address from the blockchain 2 and stores the collected data in the transaction data 21 (S10).

Next, the bitcoin transaction collection unit 10 extracts bitcoin addresses appearing in the collected transactions, and adds the bitcoin addresses to bitcoin address data 20 without duplication (S11).

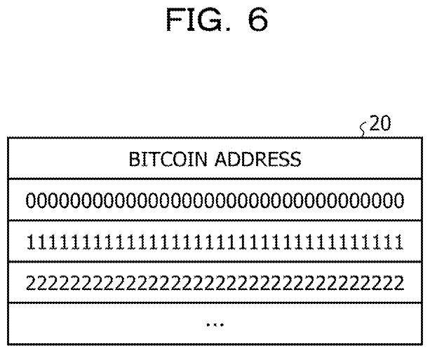

FIG. 6 is an explanatory diagram illustrating an example of the bitcoin address data 20. As illustrated in FIG. 6, the bitcoin address data 20 is data that stores the bitcoin addresses extracted by the bitcoin transaction collection unit 10 and is used for the purpose of duplication check.

Returning to FIG. 5, following 511, the bitcoin transaction collection unit 10 collects the transactions for the extracted bitcoin addresses from the blockchain 2 and stores the collected data in the transaction data 21 (S12).

Next, the bitcoin transaction collection unit 10 extracts an unidentified bitcoin address not registered in the bitcoin address data 20 from among the bitcoin addresses appearing in the transactions collected up to S12 (S13). Next, the bitcoin transaction collection unit 10 collects the transaction for the unidentified bitcoin address from the blockchain 2, stores the collected data in the transaction data 21 (S14), and terminates the processing.

Returning to FIG. 1, the graph creation/comparison unit 11 is a processing unit that refers to the transaction data 21 collected from the blockchain 2 and performs processing regarding bitcoin transaction graph creation/selection (S2) and bitcoin transaction graph comparison (S3).

Specifically, in S2, the graph creation/comparison unit 11 receives the malicious bitcoin address, a preliminary period, a verification target period, a bitcoin transaction condition, a selection threshold, and the transaction data 21 as inputs and performs graph creation processing and node selection processing.

Here, the verification target period is a target period in which a transaction is verified, and the preliminary period is a period before the verification target period (a part may overlap with the verification target period). The bitcoin transaction condition is a condition indicating transaction content of a bitcoin to be extracted. The selection threshold is a threshold set in advance for selecting a frequency in transactions or the like.

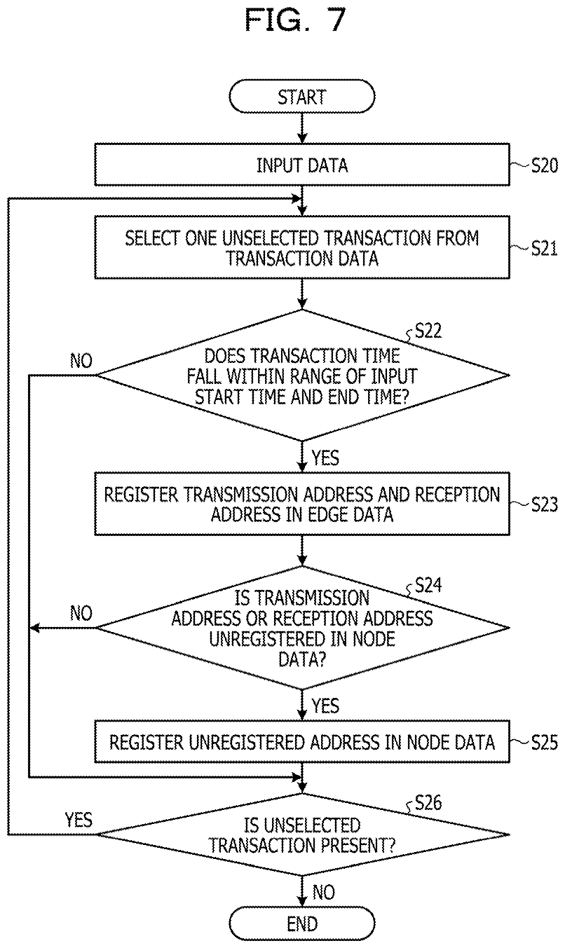

FIG. 7 is a flowchart illustrating an example of the graph creation processing. As illustrated in FIG. 7, when the processing is started, the graph creation/comparison unit 11 receives data input (S20). The data input in S20 includes a start time and an end time for the verification target period or the preliminary period, and the transaction data 21.

Next, the graph creation/comparison unit 11 selects one unselected transaction from the input transaction data 21 (521). Next, the graph creation/comparison unit 11 determines whether the time of the selected transaction falls within a range of the input start time and end time (S22). In a case where the transaction time is not within the range (S22: No), the graph creation/comparison unit 11 proceeds the processing to S26.

In a case where the transaction time is within the range (S22: Yes), the graph creation/comparison unit 11 registers the transmission bitcoin address and the reception bitcoin address in the selected transaction to edge data with identification information (edge ID) (523).

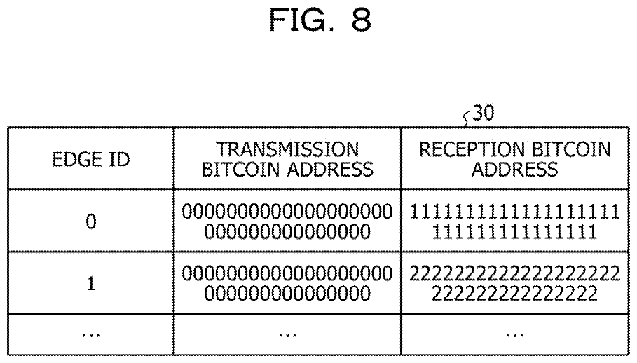

FIG. 8 is an explanatory diagram for describing an example of the edge data. As illustrated in FIG. 8, edge data 30 stores the transmission bitcoin address and the reception bitcoin address together with the edge ID for each transaction corresponding to the range of the start time and end time.

Returning to FIG. 7, following S23, the graph creation/comparison unit 11 determines whether the transmission bitcoin address or the reception bitcoin address is unregistered in the node data (S24). In a case where the transmission bitcoin address or the reception bitcoin address is unregistered in the node data (S24: Yes), the graph creation/comparison unit 11 registers the unregistered address (transmission bitcoin address or reception bitcoin address) to the node data with identification information (node ID) (S25). Thereby, the transmission bitcoin address and the reception bitcoin address regarding each transaction corresponding to the range of the start time and end time are registered in the node data without duplication.

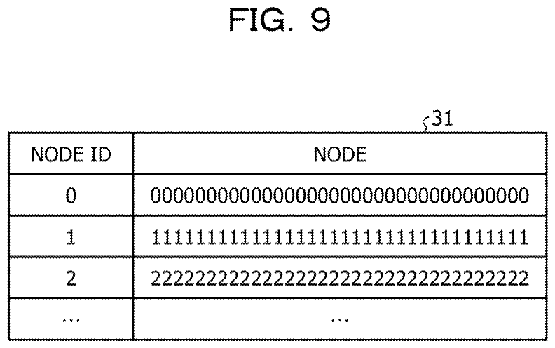

FIG. 9 is an explanatory diagram for describing an example of the node data. As illustrated in FIG. 9, node data 31 stores node information (address) corresponding to the transmission bitcoin address and the reception bitcoin address together with the node ID.

Returning to FIG. 7, in a case where the transmission bitcoin address and the reception bitcoin address are already registered in the node data 31 (S24: No), the graph creation/comparison unit 11 skips S25 and proceeds the processing to S26. In S26, the graph creation/comparison unit 11 determines presence or absence of an unselected transaction. In a case where the unselected transaction is present (S26: Yes), the graph creation/comparison unit 11 returns the processing to S21. In a case where the unselected transaction is not present (S26: No), the graph creation/comparison unit 11 terminates the processing. Thereby, the graph creation/comparison unit 11 repeats the processing of S21 to S26 until there are no unselected transactions.

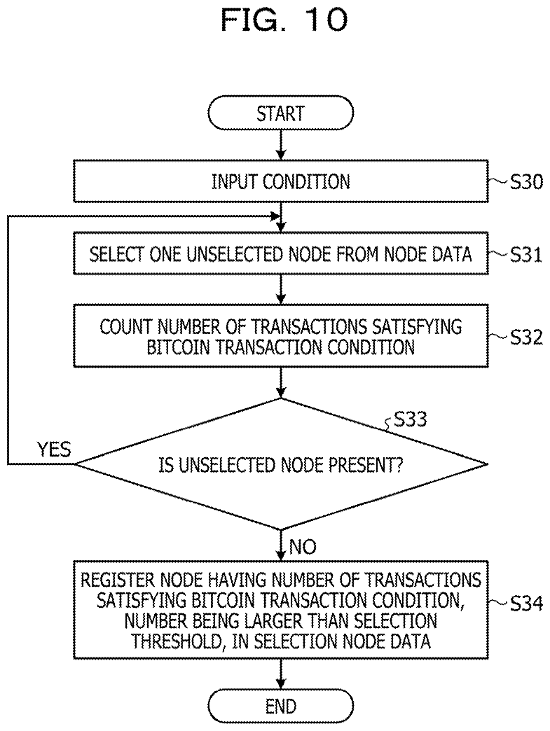

FIG. 10 is a flowchart illustrating an example of the node selection processing. Since the bitcoin address is anonymous and can be used without restrictions in the number, attackers may use disposable bitcoin addresses for temporary purposes. The node selection processing illustrated in FIG. 10 is carried out for the purpose of selecting an important bitcoin address from such disposable bitcoin addresses.

Furthermore, in the node selection processing, the bitcoin transaction condition and the selection threshold to be satisfied by the cryptocurrency (bitcoin) to be selected are given as inputs. In the bitcoin transaction condition, a condition indicating transaction content of the bitcoin to be extracted is specified, but a large-scale transaction (transaction of a certain volume or more) as in a known method can also be specified. However, in a case where an Internet protocol (IP) address of a C&C server or the like is concealed in a small transaction volume, the bitcoin address that repeatedly carries out such a transaction (a transaction volume in a certain range) may be preferentially detected. Therefore, in the present embodiment, the bitcoin transaction condition for extracting transactions of a transaction volume equal to or less than a predetermined value is specified according to the case where the IP address of the C&C server or the like is concealed. Furthermore, as the selection threshold, a threshold of a frequency corresponding to the repeated transactions is given as an input. Furthermore, the edge data 30 and the node data 31 in the graph creation processing and the transaction data 21 are given as inputs in addition to the bitcoin transaction condition and the selection threshold.

As illustrated in FIG. 10, when the processing is started, the graph creation/comparison unit 11 receives the inputs of conditions such as the above-described bitcoin transaction condition and the selection threshold (S30). Next, the graph creation/comparison unit 11 selects one unselected node from the node data 31 (S31). Next, the graph creation/comparison unit 11 counts the number of transactions satisfying the bitcoin transaction condition on the basis of the transaction data 21 (S32).

Next, the graph creation/comparison unit 11 determines the presence or absence of an unselected node (S33), and returns the processing to S31 in a case where the unselected node is present (S33: Yes). In this way, the graph creation/comparison unit 11 repeats the processing of S31 and S32 until there is no unselected node from the node data 31.

In the case where there is no unselected node (S33: No), the graph creation/comparison unit 11 registers the node having the number of transactions satisfying the bitcoin transaction condition, the number being larger than the selection threshold, to selection node data, together with the identification information (selection node ID), the number of transactions, and the like (S34), and terminates the processing.

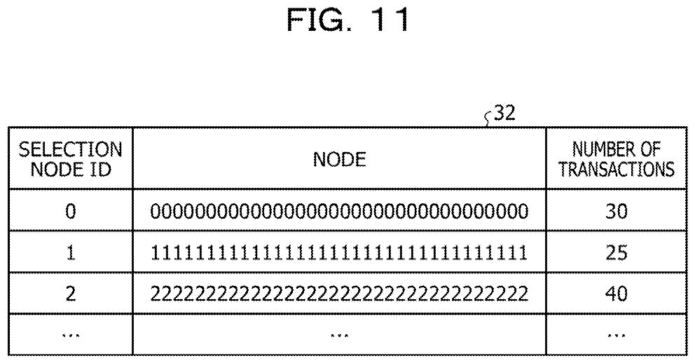

FIG. 11 is an explanatory diagram for describing an example of the selection node data. As illustrated in FIG. 11, selection node data 32 stores the node (transmission bitcoin address or reception bitcoin address) selected as the node having the number of transactions satisfying the bitcoin transaction condition, the number being larger than the selection threshold, and the number of transactions, together with the selection node ID. For example, the selection node data 32 stores information of the transmission bitcoin address or the reception bitcoin address in which a transaction with the transaction volume equal or less than a predetermined value and repeated a predetermined number or more has been performed.

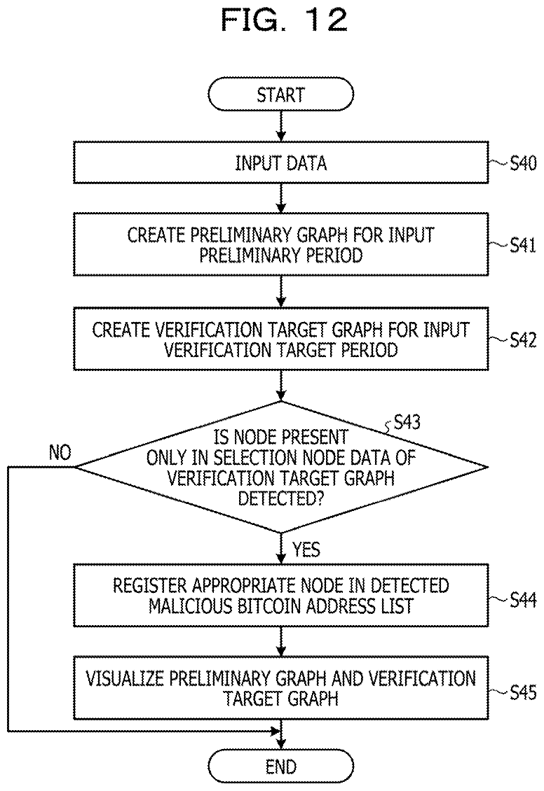

Returning to FIG. 1, following S2, the graph creation/comparison unit 11 performs graph comparison processing regarding the bitcoin transaction graph comparison (S3). FIG. 12 is a flowchart illustrating an example of graph comparison processing.

When the processing is started, the graph creation/comparison unit 11 receives data inputs (S40). The data inputs in the graph comparison processing include the preliminary period, the verification target period, and the transaction data 21.

Next, the graph creation/comparison unit 11 inputs the start time and end time of the preliminary period into the graph creation processing, and creates the node data 31 and the edge data 30 regarding a preliminary graph 34. Furthermore, the graph creation/comparison unit 11 executes the node selection processing and creates the selection node data 32 regarding the preliminary graph 34. By creating the node data 31, the edge data 30, and the selection node data 32 regarding the preliminary period in this way, the graph creation/comparison unit 11 creates the preliminary graph 34 for the input preliminary period (S41).

Next, the graph creation/comparison unit 11 similarly inputs the start time and end time of the verification target period into the graph creation processing, and creates the node data 31 and the edge data 30 regarding a verification target graph 35. Furthermore, the graph creation/comparison unit 11 executes the node selection processing and creates the selection node data 32 regarding the verification target graph 35. By creating the node data 31, the edge data 30, and the selection node data 32 regarding the verification target period in this way, the graph creation/comparison unit 11 creates the verification target graph 35 for the input verification target period (S42).

Next, the graph creation/comparison unit 11 compares the created preliminary graph 34 and the verification target graph 35, that is, the node data of the preliminary graph 34 and the node data of the verification target graph 35. Next, the graph creation/comparison unit 11 determines whether a node existing only in the selection node data 32 of the verification target graph 35, that is, a new node appearing in the verification target period is detected (S43).

When a new node is detected (S43: Yes), the graph creation/comparison unit 11 registers information (bitcoin address) of the appropriate node together with identification information (detection ID) in a detected malicious bitcoin address list (S44).).

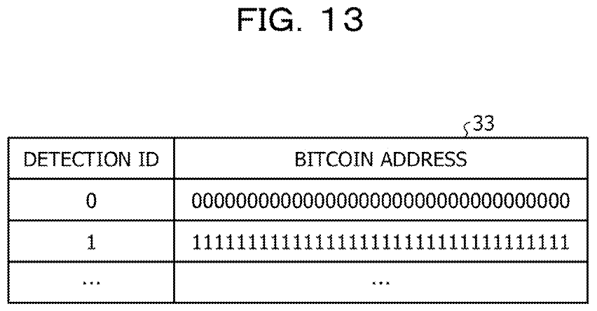

FIG. 13 is an explanatory diagram for describing an example of the detected malicious bitcoin address list. As illustrated in FIG. 13, a detected malicious bitcoin address list 33 stores a bitcoin address (transmission bitcoin address or reception bitcoin address) regarding the new malicious bitcoin address detected by the graph creation/comparison unit 11 for each detection ID.

Returning to FIG. 12, following S44, the graph creation/comparison unit 11 notifies the output unit 13 of the created preliminary graph 34 and verification target graph 35. The output unit 13 outputs and displays the preliminary graph 34 and the verification target graph 35 notified by the graph creation/comparison unit 11 on a display or the like for visualization (S45) and terminates the processing. That is, the output unit 13 is an example of a display output unit. Note that, in a case where a new node is not detected (S43: No), the graph creation/comparison unit 11 terminates the processing without registering the node information to the detected malicious bitcoin address list.

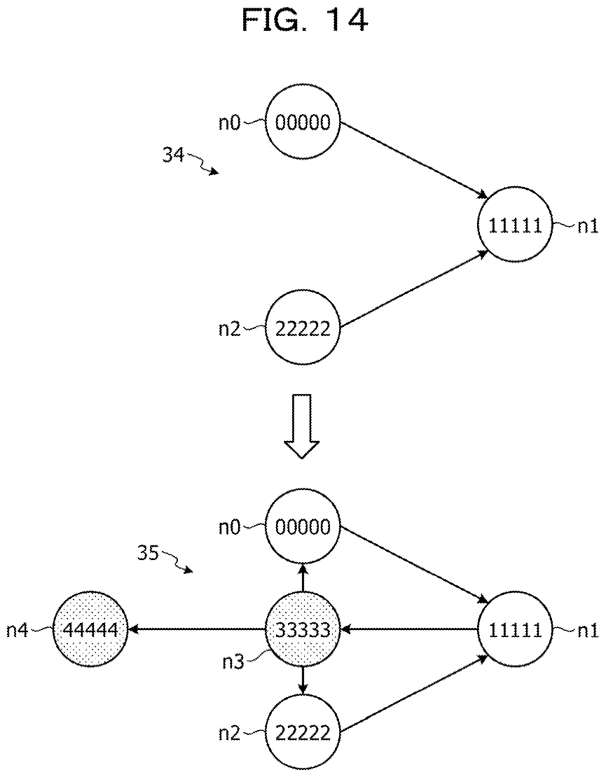

FIG. 14 is an explanatory diagram for describing an example of the preliminary graph 34 and the verification target graph 35. Note that, in the example of FIG. 14, the bitcoin addresses of the nodes (n0 to n4) in the preliminary graph 34 and the verification target graph 35 are abbreviated to the first five characters.

As illustrated in FIG. 14, the preliminary graph 34 is a graph illustrating respective cryptocurrency addresses (bitcoin addresses) of a transaction source and a transaction partner as nodes (n0 to n2) in the preliminary period on the basis of the node data 31, the edge data 30, and the selection node data 32 created for the preliminary period.

Similarly, the verification target graph 35 is a graph illustrating the respective cryptocurrency addresses of the transaction source and the transaction partner as nodes (n0 to n4) in the verification target period on the basis of the node data 31, the edge data 30, and the selection node data 32 created for the verification target period.

Specifically, the preliminary graph 34 and the verification target graph 35 are created by connecting nodes included in the selection node data 32 among the respective nodes of the node data 31 in the transaction relationship indicated by the edge data 30.

The preliminary graph 34 of the illustrated example visualizes that the bitcoin is sent from the bitcoin addresses of “00000” and “22222” to the bitcoin address of “11111”. Furthermore, the verification target graph 35 of the illustrated example visualizes that “33333” and “44444” are added as detected malicious bitcoin addresses to the preliminary graph 34.

In S45, the output unit 13 outputs and displays the preliminary graph 34 and the verification target graph 35 on a display or the like, so that the graphs can be easily compared with each other. Furthermore, when outputting and displaying the verification target graph 35, the output unit 13 may display nodes (nodes n3 and n4 in the illustrated example) newly detected in S43 in a display mode different from the other nodes (shaded display in the illustrated example). Note that the display mode is not limited to the shaded display and may be a highlighted display such as a blinking display.

As described above, the graph creation/comparison unit 11 specifies the cryptocurrency addresses of the transaction source (transmission side) and the transaction partner (reception side) in which the cryptocurrency (bitcoin) transaction satisfying the bitcoin transaction condition has been performed within the verification target period in which the inputs are received on the basis of the transaction data 21. Next, the graph creation/comparison unit 11 creates the verification target graph 35 having the respective cryptocurrency addresses specified in the verification target period as nodes.

Similarly, the graph creation/comparison unit 11 specifies the cryptocurrency addresses of the transaction source (transmission side) and the transaction partner (reception side) in which the cryptocurrency (bitcoin) transaction satisfying the bitcoin transaction condition has been performed within the preliminary period in which the inputs are received on the basis of the transaction data 21. Next, the graph creation/comparison unit 11 creates the preliminary graph 34 having the respective cryptocurrency addresses specified in the preliminary period as nodes. That is, the graph creation/comparison unit 11 is an example of a creation unit.

Furthermore, the graph creation/comparison unit 11 detects a new cryptocurrency address (bitcoin address) in which the cryptocurrency transaction has been performed under the bitcoin transaction condition on the basis of the created preliminary graph 34 and verification target graph 35, and registers the cryptocurrency address in the detected malicious bitcoin address list 31 That is, the graph creation/comparison unit 11 is an example of a detection unit.

Returning to FIG. 1, the threat information verification unit 12 performs C&C IP decryption for estimating an IP address (C&C IP 22) on the basis of transaction content (for example, transaction volume) regarding the bitcoin address included in the detected malicious bitcoin address list 33 (S4).

Specifically, the threat information verification unit 12 receives the malicious bitcoin address, the detected malicious bitcoin address list 33, the transaction data 21, and a decryption algorithm as inputs. Next, the threat information verification unit 12 specifies the transaction content regarding the bitcoin address included in the detected malicious bitcoin address list 33 from the transaction data 21. Next, the threat information verification unit 12 estimates the IP address concealed in the transaction content (for example, transaction volume) by decrypting the specified transaction content using the input decryption algorithm.

Furthermore, the threat information verification unit 12 performs threat information verification (S5) of querying a threat information server 3 about the decrypted C&C IP 22, and verifying whether the IP address regarding the attacker is registered in threat information and outputting a verification result.

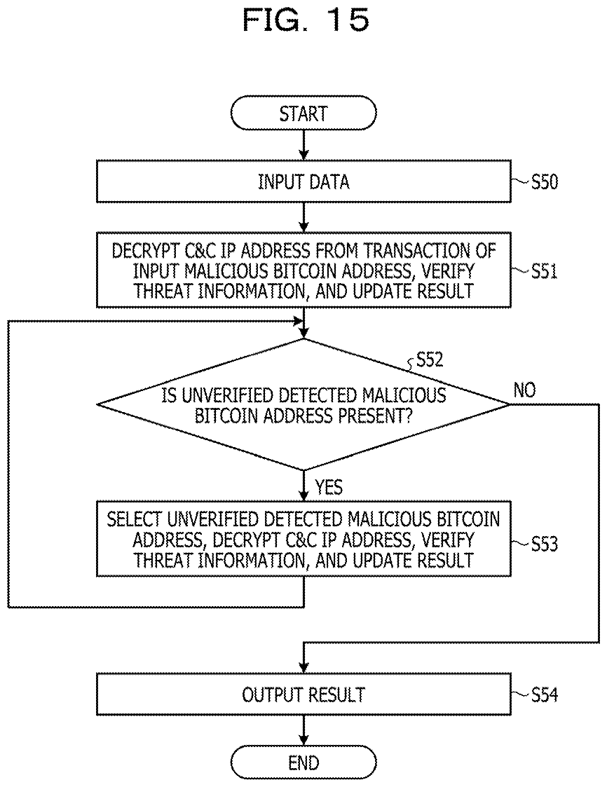

FIG. 15 is a flowchart illustrating an example of threat information verification processing. As illustrated in FIG. 15, when the processing is started, the threat information verification unit 12 receives the data inputs such as the malicious bitcoin address, the detected malicious bitcoin address list 33, the transaction data 21, and the decryption algorithm (S50).

Next, the threat information verification unit 12 decrypts the C&C IP 22 from the input transaction data 21 of the malicious bitcoin address using the decryption algorithm. Next, the threat information verification unit 12 verifies whether the decrypted C&C IP 22 is registered in the threat information of the threat information server 3 and updates the result (S51).

Next, the threat information verification unit 12 determines whether an unverified malicious bitcoin address is present in the detected malicious bitcoin address list 33 (S52). In a case where an unverified malicious bitcoin address is present (S52: Yes), the threat information verification unit 12 selects the unverified malicious bitcoin address and decrypts the C&C IP 22 from the transaction data 21 of the selected malicious bitcoin address. Next, the threat information verification unit 12 verifies whether the decrypted C&C IP 22 is registered in the threat information of the threat information server 3 and updates the result (S53).

In a case where no unverified malicious bitcoin address is present (S52: No), the threat information verification unit 12 outputs the verification results in S51 to S53 to the output unit 13 (S54) and terminates the processing.

Returning to FIG. 1, the output unit 13 is a processing unit that outputs a file such as a processing result and outputs a display. Specifically, the output unit 13 outputs the verification result of the threat information verification unit 12 to the display or the like. Furthermore, as described above, the output unit 13 outputs the display of the preliminary graph 34 and the verification target graph 35 to the display or the like.

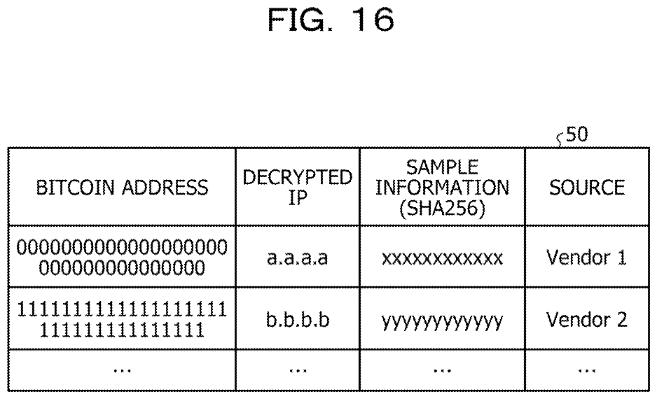

FIG. 16 is an explanatory diagram for describing an example of the verification result. As illustrated in FIG. 16, the output unit 13 outputs and displays a verification result 50 of the threat information verification unit 12 on, for example, the display or the like. As a result, a user can easily know the verification result 50 regarding the bitcoin address included in the detected malicious bitcoin address list 33.

Specifically, the verification result 50 includes “decrypted IP”, “sample information (SHA256)”, “source”, and the like as well as the “bitcoin address” included in the detected malicious bitcoin address list 33. The “decrypted IP” is information regarding the C&C IP 22 decrypted from the transaction content in the “bitcoin address”. The “sample information (SHA256)” is information indicating a sample communicated to the C&C IP 22, using a hash value such as MD5, SHA1, or SHA256 (SHA256 in the illustrated example). The “source” is information of, for example, a vendor and a uniform resource locator (URL) from which the threat information has been obtained.

As described above, the detection device 1 specifies the cryptocurrency addresses (bitcoin addresses) of the transaction source and the transaction partner in which the cryptocurrency transaction satisfying the predetermined transaction condition has been performed in the preliminary period on the basis of the blockchain 2, and creates the preliminary graph 34 using the respective cryptocurrency addresses of the transaction source and the transaction partner as nodes. Furthermore, the detection device 1 specifies the cryptocurrency addresses of the transaction source and the transaction partner in which the cryptocurrency transaction satisfying the predetermined transaction condition has been performed in the verification target period later than the preliminary period on the basis of the blockchain 2, and creates the verification target graph 35 using the respective cryptocurrency addresses of the transaction source and the transaction partner as nodes. The detection device 1 detects a new cryptocurrency address that performs the cryptocurrency transaction under the predetermined transaction condition on the basis of the created preliminary graph 34 and verification target graph 35.

In the malicious activities of indirectly abusing the cryptocurrency such as concealing information for abuse such as attack infrastructure information (for example, a C&C address) in transaction content and sending the information by a public distributed ledger, small amounts of transactions including, for example, transaction content (transaction volume or the like) as a sign are repeatedly performed. Therefore, by specifying the cryptocurrency addresses that perform a suspicious transaction satisfying a transaction condition (for example, the transaction volume is a predetermined value or less) included in the transaction content including information for abuse such as a C&C address as a sign, the cryptocurrency addresses functioning in the malicious activities can be specified. Furthermore, by detecting a new cryptocurrency address on the basis of the preliminary graph 34 in the preliminary period and the verification target graph 35 in the verification target period, the cryptocurrency address newly added by the attacker for malicious activities can be traced, for example. Furthermore, the user can recognize the transaction content with the new cryptocurrency address, analyze the transaction content, and take countermeasures against it. For example, in the case where the transaction content includes a C&C address as a sign, the attacker's C&C server can be proactively recognized and countermeasures are taken. In this way, the detection device 1 can support the verification of the abuse of the cryptocurrency.

Furthermore, the detection device 1 estimates the IP address (C&C

IP 22) on the basis of the transaction volume of the transaction regarding the detected cryptocurrency addresses. As a result, the detection device 1 can specify, for example, the IP address (such as the C&C address 22) of the attack infrastructure concealed in the transaction volume using the cryptocurrency, for example.

Furthermore, the detection device 1 verifies whether the estimated IP address is registered in the threat information indicating the IP address regarding the attacker, and outputs the verification result. As a result, the detection device 1 can easily verify whether the IP address estimated by the transaction of the detected cryptocurrency address corresponds to an actual threat regarding the attacker.

Furthermore, the predetermined transaction condition for specifying the cryptocurrency address includes the transaction volume in the cryptocurrency transaction being equal to or less than a predetermined value. In the malicious activities of indirectly abusing the cryptocurrency, information to be abused in a small amount of cryptocurrency transaction (for example, about 61,166 satoshi in the case where the cryptocurrency is bitcoin) is sent, for example. Therefore, the cryptocurrency addresses to be used in the malicious activities can be narrowed down by using a transaction with the transaction volume equal to or less than a predetermined value as the condition.

Furthermore, the detection device 1 specifies the cryptocurrency addresses of the transaction source and the transaction partner in which the transaction satisfying the predetermined transaction condition has been performed the predetermined number of times, and creates the preliminary graph 34 and the verification target graph 35. In the malicious activities indirectly abusing the cryptocurrency, the information for abuse may be concealed in a plurality of transaction contents in the repeatedly performed cryptocurrency transactions. Therefore, by specifying the transaction satisfying the predetermined transaction condition the predetermined number of times, the transaction used in the malicious activities can be specified.

Furthermore, the detection device 1 specifies the cryptocurrency addresses of the transaction source and the transaction partner in which the cryptocurrency transaction satisfying the predetermined transaction condition has been performed using the preset cryptocurrency address as a starting point, and creates the preliminary graph 34 and the verification target graph 35. Thereby, the detection device 1 can easily specify the related cryptocurrency addresses according to the preset cryptocurrency address (for example, the malicious bitcoin address) and the transaction.

Furthermore, the detection device 1 outputs and displays the created preliminary graph 34 and verification target graph 35. Thereby, the user can easily grasp the cryptocurrency address having newly appeared in the verification target period by comparing the output and displayed preliminary graph 34 and verification target graph 35.

Furthermore, the detection device 1 outputs and displays the nodes (see the nodes n3 and n4 in FIG. 14) corresponding to the new cryptocurrency addresses in the display mode different from the other nodes in the verification target graph 35. Thereby, in the detection device 1, the nodes corresponding to the new cryptocurrency addresses can be easily recognized. Therefore, the user can easily grasp the relationship between the new cryptocurrency addresses and the cryptocurrency addresses in which a transaction has been performed with the new cryptocurrency addresses.

Note that each of the illustrated components in each of the devices is not necessarily physically configured as illustrated in the drawings. In other words, the specific aspects of distribution and integration of the respective devices are not limited to the illustrated aspects, and all or some of the devices can be functionally or physically distributed and integrated in any unit in accordance with various loads, use status, and the like.

Furthermore, the various processing functions executed by the detection device 1 may be entirely or optionally partially executed on a central processing unit (CPU) (or microcomputer such as microprocessor unit (MPU) or micro controller unit (MCU)).

Furthermore, it is needless to say that whole or any part of the various processing functions may be executed by a program to be analyzed and executed on a CPU (or microcomputer such as MPU or MCU) or on hardware by wired logic. Furthermore, the various processing functions executed by the detection device 1 may be executed by a plurality of computers in cooperation through cloud computing.

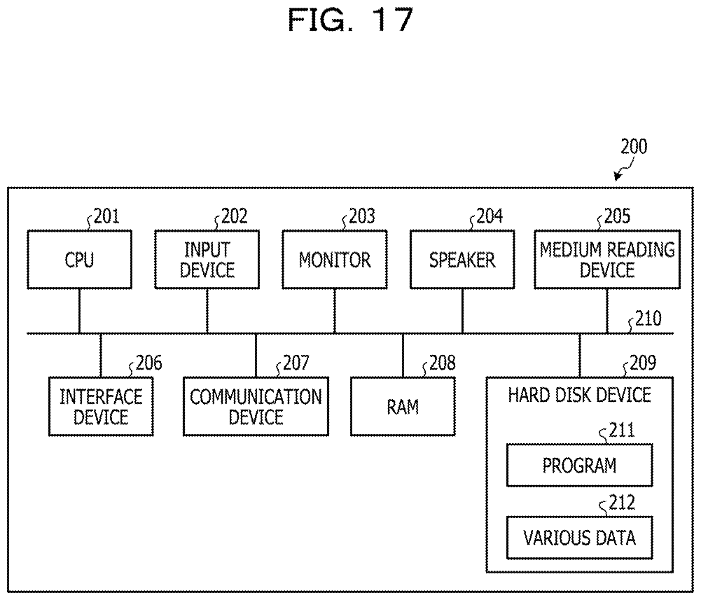

Meanwhile, the various types of processing described in the above embodiment can be implemented by execution of a prepared program on a computer. Thus, hereinafter, an example of a computer configuration (hardware) that executes a program having functions similar to the above embodiment will be described. FIG. 17 is a block diagram illustrating an example of a computer configuration.

As illustrated in FIG. 17, a computer 200 includes a CPU 201 that executes various types of arithmetic processing, an input device 202 that receives data input, a monitor 203, and a speaker 204. Furthermore, the computer 200 includes a medium reading device 205 that reads a program and the like from a storage medium, an interface device 206 that is connected to various devices, and a communication device 207 that is connected to and communicates with an external device in a wired or wireless manner. Furthermore, the detection device 1 includes a random access memory (RAM) 208 that temporarily stores various types of information, and a hard disk device 209. Moreover, each of the units (201 to 209) in the computer 200 is connected to a bus 210.

The hard disk device 209 stores a program 211 for executing various types of processing in the functional configurations (for example, the bitcoin transaction collection unit 10, the graph creation/comparison unit 11, the threat information verification unit 12, and the output unit 13) described in the above embodiment. Furthermore, the hard disk device 209 stores various data 212 that the program 211 refers to. The input device 202 receives, for example, an input of operation information from an operator. The monitor 203 displays, for example, various screens operated by the operator. The interface device 206 is connected to, for example, a printing device or the like. The communication device 207 is connected to a communication network such as a local area network (LAN), and exchanges various types of information with an external device via the communication network.

The CPU 201 reads the program 211 stored in the hard disk device 209, and expands the program 211 into the RAM 208 and executes the program 211 to perform the various types of processing regarding the above-described functional configurations (for example, the bitcoin transaction collection unit 10, the graph creation/comparison unit 11, the threat information verification unit 12, and the output unit 13). Note that the program 211 may not be prestored in the hard disk device 209. For example, the computer 200 may read out the program 211 stored in a storage medium that is readable by the computer 200 and may execute the program 211. The storage medium that is readable by the computer 200 corresponds to, for example, a portable recording medium such as a compact disk read only memory (CD-ROM), a digital versatile disk (DVD), or a universal serial bus (USB) memory, a semiconductor memory such as a flash memory, a hard disk drive, or the like. Alternatively, the program 211 may be prestored in a device connected to a public line, the Internet, a LAN, or the like, and the computer 200 may read out the program 211 from the device to execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
identifying, by using a blockchain indicating a cryptocurrency transaction, first cryptocurrency addresses of a transaction source and a transaction partner in which the cryptocurrency transaction satisfying a predetermined condition has been performed in a first period;
generating, by using the first cryptocurrency addresses, a first transaction graph having the respective cryptocurrency addresses of the transaction source and the transaction partner as nodes;
identifying, by using the blockchain, second cryptocurrency addresses of a transaction source and a transaction partner in which the cryptocurrency transaction satisfying the predetermined condition has been performed in a second period later than the first period;
generating, by using the second cryptocurrency addresses, a second transaction graph having the respective cryptocurrency addresses of the transaction source and the transaction partner as nodes; and
detecting, by using the first transaction graph and the second transaction graph, a new cryptocurrency address in which the cryptocurrency transaction has been performed under the predetermined condition.

2. The non-transitory computer-readable storage medium according to claim 1, the method further comprising
estimating an internet protocol (IP) address on the basis of transaction content of a transaction regarding the detected cryptocurrency addresses.

3. The non-transitory computer-readable storage medium according to claim 2, the method further comprising
verifying whether the estimated IP address is registered in threat information indicating an IP address regarding an attacker and outputting a verification result.

4. The non-transitory computer-readable storage medium according to claim 1, wherein
the condition includes that a transaction volume in the cryptocurrency transaction is equal to or less than a predetermined value.

5. The non-transitory computer-readable storage medium according to claim 1, the method further comprising
specifying the cryptocurrency addresses of the transaction source and the transaction partner in which the transaction satisfying the transaction condition has been performed a predetermined number of times.

6. The non-transitory computer-readable storage medium according to claim 1, the method further comprising
specifying the cryptocurrency addresses of the transaction source and the transaction partner in which the transaction satisfying the transaction condition has been performed using a preset cryptocurrency address as a starting point.

7. The non-transitory computer-readable storage medium according to claim 1, the method further comprising
outputting and displaying the created first transaction graph and the created second transaction graph.

8. The non-transitory computer-readable storage medium according to claim 7, the method further comprising
displaying outputs and displays a node corresponding to the new cryptocurrency address in a display mode different from other nodes in the second transaction graph.

9. A detection method executed by a computer, the method comprising:
identifying, by using a blockchain indicating a cryptocurrency transaction, first cryptocurrency addresses of a transaction source and a transaction partner in which the cryptocurrency transaction satisfying a predetermined condition has been performed in a first period;
generating, by using the first cryptocurrency addresses, a first transaction graph having the respective cryptocurrency addresses of the transaction source and the transaction partner as nodes;
identifying, by using the blockchain, second cryptocurrency addresses of a transaction source and a transaction partner in which the cryptocurrency transaction satisfying the predetermined condition has been performed in a second period later than the first period;
generating, by using the second cryptocurrency addresses, a second transaction graph having the respective cryptocurrency addresses of the transaction source and the transaction partner as nodes; and
detecting, by using the first transaction graph and the second transaction graph, a new cryptocurrency address in which the cryptocurrency transaction has been performed under the predetermined condition.

10. A detection device, comprising:
a memory; and
a processor coupled to the memory and the processor configured to:
identify, by using a blockchain indicating a cryptocurrency transaction, first cryptocurrency addresses of a transaction source and a transaction partner in which the cryptocurrency transaction satisfying a predetermined condition has been performed in a first period,
generate, by using the first cryptocurrency addresses, a first transaction graph having the respective cryptocurrency addresses of the transaction source and the transaction partner as nodes,
identify, by using the blockchain, second cryptocurrency addresses of a transaction source and a transaction partner in which the cryptocurrency transaction satisfying the predetermined condition has been performed in a second period later than the first period,
generate, by using the second cryptocurrency addresses, a second transaction graph having the respective cryptocurrency addresses of the transaction source and the transaction partner as nodes, and
detect, by using the first transaction graph and the second transaction graph, a new cryptocurrency address in which the cryptocurrency transaction has been performed under the predetermined condition.
